(19) United States
(12) Patent Application Publication
(10) Pub. No.: US 2016/0026019 A1
(43) Pub. Date: Jan. 28, 2016

(54) MOTHER SUBSTRATE FOR DISPLAY DEVICE, DISPLAY DEVICE, AND MANUFACTURING METHOD THEREOF

(71) Applicant: Samsung Display Co., Ltd., Yongin-City (KR)

(72) Inventors: Byung Seok CHOI, Seoul (KR); Su Jung HUH, Yongin-si (KR); Byoung Yong KIM, Seoul (KR); Ji Eun LEE, Seoul (KR); Jun Ho SONG, Seongnam-si (KR)

(21) Appl. No.: 14/551,326

(22) Filed: Nov. 24, 2014

(30) Foreign Application Priority Data
Jul. 25, 2014 (KR) 10-2014-0095094

(51) Int. Cl. G02F 1/1339; G02F 1/1335

(52) U.S. Cl. CPC G02F 1/1339; G02F 1/133514

(57) ABSTRACT

A mother substrate for a display device, includes an upper mother substrate and a lower mother substrate each divided into, from among areas of the display device, a display area which displays an image, a sealing area which surrounds the display area and in which a seal material is disposed, and an outer area disposed outside the sealing area, in which a pad area is disposed and from which a signal is applied to the display area; and a spacer between the upper mother substrate and the lower mother substrate, and in the outer area. The spacer is disposed at a cutting line at which the upper mother substrate and the lower mother substrate are separated from the mother substrate to form the display device.

This application claims priority to Korean Patent Application No. 10-2014-0095094 filed on Jul. 25, 2014, and all the benefits accruing therefrom under 35 U.S.C. §119, the entire contents of which are incorporated herein by reference.

### BACKGROUND

(a) Field

The invention relates to a mother substrate for a display device, a display device, and a manufacturing method thereof.

(b) Description of the Related Art

A liquid crystal display device represents one of the most used flat panel displays. The liquid crystal display device includes a lower substrate and an upper substrate on which field generating electrodes such as a pixel electrode and a common electrode are formed. The two substrates form a liquid crystal panel of the liquid crystal display device when the two substrates are bonded together and a liquid crystal material is sealed therebetween.

The liquid crystal display device generates an electric field in a liquid crystal layer including the liquid crystal material by applying a voltage to the field generating electrodes, determines alignment of liquid crystal molecules of the liquid crystal layer, and displays an image by controlling polarization of incident light.

### SUMMARY

A liquid crystal panel has a structure in which a lower substrate and an upper substrate among two substrates are bonded by a sealing material while the liquid crystal material is provided therebetween. Conventionally, signal lines for transmitting signals and thin film transistors that are switching elements are provided on the lower substrate, and red, green and blue (“RGB”) light blocking members, color filters used for colorization and column spacers are provided on the upper substrate.

The liquid crystal display device is formed through an incision process which divides a predetermined number of liquid crystal panels that are manufactured simultaneously when a lower mother substrate is bonded to an upper mother substrate into respective liquid crystal panels.

In this instance, regarding the process for incising the simultaneously formed liquid crystal panels, the upper mother substrate and the lower mother substrate are incised along a cutting line such as by using a scribing blade, no vertical crack is generated in a thickness direction of the substrate so a glass break is generated, and an area in the substrate where the cutting lines cross is relatively thinner than a pixel area, such that intensity of a load of the scribing blade is less and a chipping fault occurs.

One or more exemplary embodiment of the invention provides a mother substrate for a display device, which disperses a load in a process for incising a liquid crystal panel therefrom, a display device, and a manufacturing method thereof.

An exemplary embodiment of the invention provides a mother substrate for a display device including: an upper mother substrate and a lower mother substrate each divided into, from among areas of the display device, a display area which displays an image, a sealing area which surrounds the display area and in which a seal material is disposed, and an outer area disposed outside the sealing area, in which a pad area is disposed and from which a signal is applied to the display area; and a spacer between the upper mother substrate and the lower mother substrate, and in the outer area. The spacer is disposed at a cutting line at which the upper mother substrate and the lower mother substrate are separated from the mother substrate to form the display device.

The mother substrate may include a plurality of cutting lines including: a first cutting line elongated in a first direction and in the outer area adjacent to the seal material; a second cutting line elongated parallel with the first cutting line, in the outer area, and defining the pad area; a third cutting line elongated in a second direction perpendicular to the first direction, and extending through the outer area and between display device display areas adjacent in the first direction; and a fourth cutting line elongated in the first direction and in the sealing area.

The mother substrate may further include a plurality of spacers arranged in series adjacent the first to fourth cutting lines and along the first to fourth cutting lines in the outer area.

The mother substrate may further include a plurality of spacers arranged in series overlapping the first to fourth cutting lines and along the first to fourth cutting lines in the outer area.

The spacers may have a circle, square or bar shape.

The mother substrate may further include a plurality of spacers arranged only disposed adjacent a crossing area of the first cutting line to fourth cutting line in the outer area and adjacent the third cutting line adjacent the sealing area in the outer area.

The mother substrate may further include a plurality of spacers overlapping a crossing area of the first cutting line to fourth cutting line in the outer area and overlapping the third cutting line and the fourth cutting line in the outer area adjacent to the sealing area.

The spacers may have a circle, square or bar shape.

The spacer may include a same material as at least one of a display area light blocking member, a display area color filter, and a display area column spacer on the upper mother substrate.

The spacer may include a same material as at least one of a display area color filter, a display area light blocking member, and a display area column spacer on the lower mother substrate.

Another exemplary embodiment of the invention provides a display device including: an upper substrate and a lower substrate each including a display area which displays an image, a sealing area which surrounds the display area and in which a seal material is disposed, and an outer area disposed outside the sealing area, in which a pad area is disposed and from which a signal is applied to the display area; and a spacer between the upper substrate and the lower substrate, and in the outer area. The spacer is disposed at a cutting line of a mother substrate at which the upper substrate and the lower substrate are separated from the mother substrate to form the display device.

The mother substrate may include a plurality of cutting lines including: a first cutting line elongated in a first direction and in the outer area adjacent to the seal material; a second cutting line elongated in parallel with the first cutting line, in the outer area, and defining the pad area; a third cutting line elongated in a second direction perpendicular to the first direction, and extending through the outer area and between mother substrate display device display areas adjacent in the first direction; and a fourth cutting line elongated in the first direction and in the sealing area.

The spacer may be disposed in the outer area of the upper substrate, and is disposed adjacent the seal material along the first cutting line.

The spacer may include a same material as at least one of a display area light blocking member, a display area color filter and a display area column spacer on the upper substrate.

The spacer may be disposed in the outer area of the lower substrate, and is disposed adjacent near the first to fourth cutting lines.

The spacer may include a same material as at least one of a display area color filter, a display area light blocking member and a display area column spacer on the lower substrate.

Yet another exemplary embodiment of the invention provides a method for manufacturing a display device, including: providing an upper mother substrate and a lower mother substrate each divided into, from among areas of the display device, a display area which displays an image, a sealing area which surrounds the display area and seals the display area, and an outer area disposed outside the sealing area, in which a pad area is disposed and from which a signal is applied to the display area; forming a seal material in the sealing area of the upper mother substrate or the lower mother substrate, and forming a spacer in an outer area of the upper mother substrate or the lower mother substrate, respectively; arranging the lower mother substrate and the upper mother substrate to face each other; melting the seal material and curing the seal material to bonding the lower mother substrate and the upper mother substrate to each other; incising the upper mother substrate; and incising the lower mother substrate. The incising the upper mother substrate includes incising the same along a first cutting line elongated in a first direction in the outer area adjacent to the seal material, and a second cutting line elongated parallel to the first cutting line in the outer area and defining the pad area. The incising of the lower mother substrate includes incising the same along a third cutting line elongated in a second direction perpendicular to the first direction, and extending through the outer area and between display device display areas adjacent in the first direction, and a fourth cutting line elongated in the first direction in the sealing area.

The spacer may include a same material as at least one of a display area light blocking member, a display area color filter and a display area column spacer on the upper mother substrate.

The spacer may include a same material as at least one of a display area color filter, a display area light blocking member and a display area column spacer on the lower mother substrate.

In addition to the above-described features of the invention, other characteristics and advantages of the invention will be described hereinafter, and will be clearly understood by a person skilled in the art in the technical field to which the invention belongs.

The invention provides subsequent advantages.

According to one or more exemplary embodiment of the invention, the spacer is included adjacent to or overlapping the cutting line of the outer area to reduce the glass break and the chipping fault that may occur when incising the liquid crystal display panel from the mother substrate, and improve the yield in in a method of manufacturing a liquid crystal display panel.

Also, the spacer includes a same material as, is in a same layer as or is formed at the same time or in a same process as the light blocking member, the color filter and the column spacer included in the display area to form the spacer without an additional process.

Further, the seal material is disposed between the liquid crystal display panels provided in the first direction, and an upper portion of the seal material is incised to reduce the margin in the incision process and reduce the width of the outer bezel of the liquid crystal display panels.

In addition, other characteristics and advantages of the invention can be found through the exemplary embodiments of the invention.

### BRIEF DESCRIPTION OF THE DRAWINGS

The above and other features of this disclosure will become more apparent by describing in further detail exemplary embodiments thereof with reference to the accompanying drawings, in which:

FIG. 1 shows a top plan view of an exemplary embodiment of a mother substrate for a display device according to the invention.

FIG. 2 shows a cross-sectional view of the mother substrate for a display device taken along line I-I of FIG. 1.

FIG. 3 to FIG. 5 show top plan views of other exemplary embodiments of a mother substrate for a display device according to the invention.

FIG. 6A to FIG. 6C show views of comparative example of a mother substrate for a display device.

FIG. 7 shows images for describing a glass break of a mother substrate depending on whether a spacer is provided on the mother substrate.

FIG. 8 shows images for describing a chipping fault on a mother substrate depending on whether a spacer is provided on the mother substrate.

FIG. 9 to FIG. 12 show top plan views of still other exemplary embodiments of a mother substrate for a display device according to the invention.

FIG. 13 shows a cross-sectional view of another exemplary embodiment of a mother substrate for a display device according to the invention.

FIG. 14A to FIG. 14C show an exemplary embodiment of manufacturing a display device according to the invention.

FIG. 15A to FIG. 15C show another exemplary embodiment of manufacturing a display device according to the invention.

### DETAILED DESCRIPTION

The invention will be described more fully hereinafter with reference to the accompanying drawings, in which exemplary embodiments of the invention are shown. As those skilled in the art would realize, the described embodiments may be modified in various different ways, all without departing from the spirit or scope of the invention.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

An exemplary embodiment of a mother substrate for forming a display device according to the invention will now be described with reference to accompanying drawings.

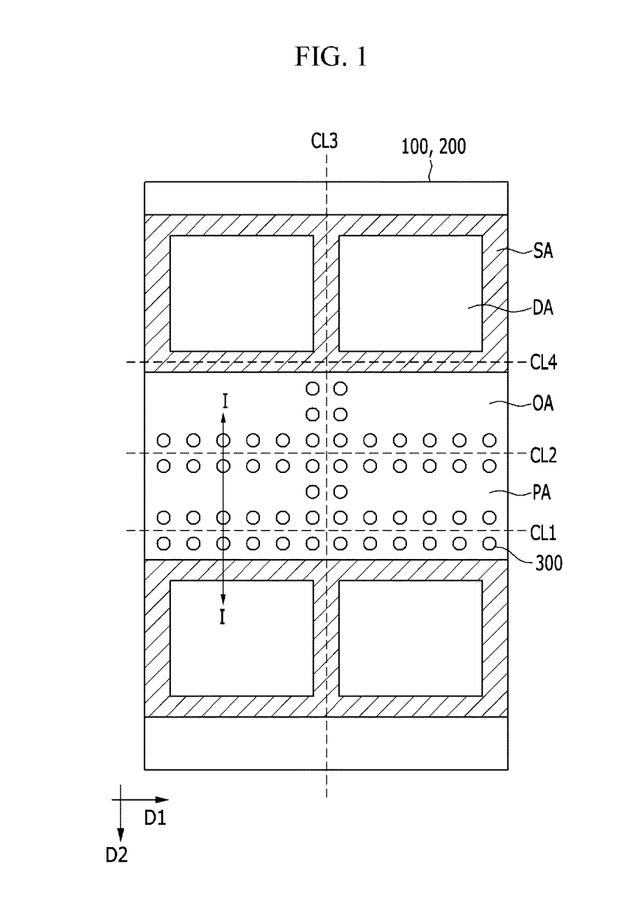

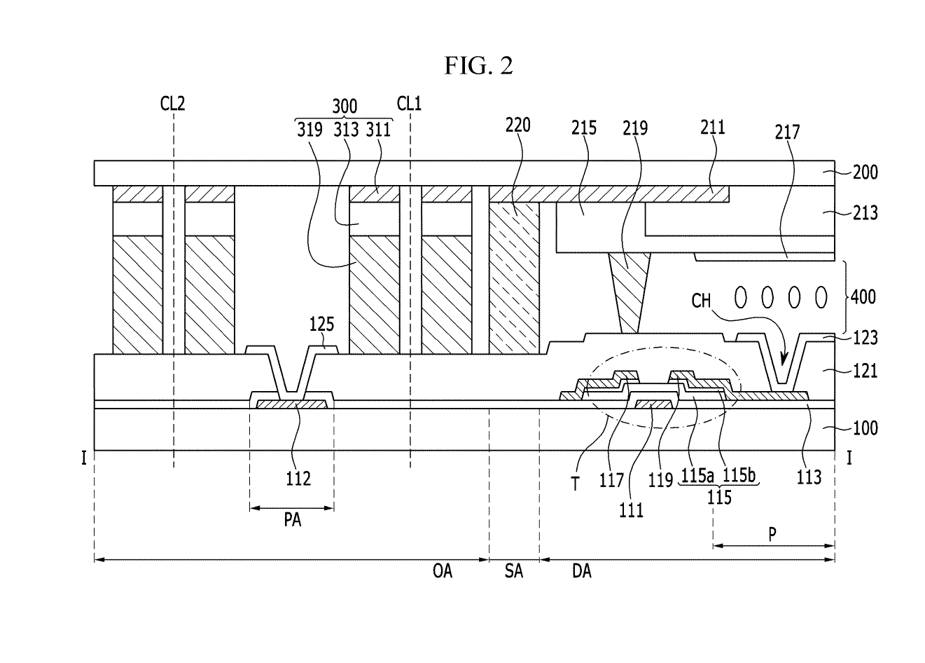

FIG. 1 shows a top plan view of an exemplary embodiment of a mother substrate for forming a display device according to the invention, and FIG. 2 shows a cross-sectional view of the mother substrate for a display device taken along line I-I of FIG. 1.

Referring to FIG. 1 and FIG. 2, a collective mother substrate for forming a display device includes a plurality of liquid crystal panels generated by combining an upper mother substrate 200 on which a predetermined pattern is formed and a lower mother substrate 100. In this instance, the upper mother substrate 200 and the lower mother substrate 100 include a display area (DA) for displaying an image, a sealing area (SA) which surrounds the display area (DA) and on which a seal material 220 is formed, and an outer area (OA) including a pad area (PA), and formed on an outer side of the sealing area (SA) and applying a signal to the display area (DA).

In one exemplary embodiment, a pixel (P) is defined when a gate line (not shown) crosses a data line (not shown) on the lower mother substrate 100 of the display area (DA), and a pixel electrode 123 is formed on the pixel (P), but the invention is not limited thereto.

The pixel electrode 123 is disposed on a passivation layer 121 and is connected to a drain electrode 119 through a contact hole (CH).

Further, in an exemplary embodiment, a thin film transistor (T) that is a switching element including a gate electrode 111, a gate insulating layer 113, a semiconductor layer 115, source and drain electrodes 117 and 119, and the passivation layer 121 is provided at a crossing point of the gate line (not shown) and the data line (not shown), but the invention is not limited thereto.

In this instance, the semiconductor layer 115 is configured with an active layer 115a including intrinsic amorphous silicon and an ohmic contact layer 115b including amorphous silicon including an impurity. A bottom gate type of thin film transistor (T) is shown in FIG. 2 to be configured with the intrinsic and impurity-included amorphous silicon 115a and 115b. An alternative exemplary embodiment may include a top gate type of thin film transistor including a polysilicon semiconductor layer as a variation.

The pad area (PA) including a gate or data pad electrode 112 connected a gate line or a data line (not shown) and a gate or data pad terminal electrode 125 is provided in the outer area (OA). An additional driving circuit (not shown) for transmitting a predetermined signal to the gate line and the data line can be disposed in the pad area (PA).

A lattice-shaped light blocking member 211 in the plan view surrounds the pixel (P) and covers an area which does not contribute to driving of liquid crystal with light. The lattice-shaped light blocking member 211 is disposed at an edge of the pixel electrode 123 and exposes the pixel electrode 123. In addition to the thin film transistor (T), the gate line (not shown) and the data line (not shown) are disposed at an inner surface of the upper mother substrate 200 facing an inner surface of the lower mother substrate 100.

Inside areas defined by the lattice of the light blocking member 211, red, green and blue color filters 213 are sequentially repeated to correspond to the respective pixels (P). An overcoat 215 is disposed to cover the light blocking member 211 and the color filter 213. The overcoat 215 is made flat to reduce or effectively prevent a step formed by the color filter 213 with respect to the upper mother substrate 200 and/or the light blocking member 211.

A common electrode 217 and a column spacer 219 are disposed on the overcoat 215.

The common electrode 217 generates an electric field in a liquid crystal layer 400 together with the pixel electrode 123 to determine alignment of liquid crystal molecules of the liquid crystal layer 400 and display an image.

The column spacer 219 maintains a gap between the lower mother substrate 100 and the upper mother substrate 200 so that liquid crystal material of the liquid crystal layer 400 may be fluidly injected.

First and second alignment layers (not shown) of which surfaces provided facing the liquid crystal layer are rubbed in a predetermined direction. The first and second alignment layers are provided between the liquid crystal layer 400 and the pixel electrode 123 and between the liquid crystal layer 400 and the common electrode 217 to uniformly arrange an initial disposal state and an alignment direction of the liquid crystal molecules the liquid crystal layer 400.

The seal material 220 is coated in the sealing area (SA) to reduce or effectively prevent leakage of the liquid crystal layer 400 from between the mother substrates 100 and 200. The seal material 220 includes a polymer solution including a combination of an epoxy resin and a curing accelerator. The polymer solution may be hardened by heating or radiation of ultraviolet (“UV”) rays to maintain a bonded state of the mother substrates 100 and 200, thereby functioning as an adhesive.

That is, the seal material 220 is formed (e.g., provided) in the sealing area (SA) surrounding the edge of the display area (DA) to function as an encapsulation material of liquid crystal cells (e.g., liquid crystal panels) defined between the mother substrates 100 and 200.

In this instance, the seal material 220 is filled in between the respective liquid crystal panels that are arranged in the first direction D1.

When the seal material 220 is not filled between the liquid crystal panels, a predetermined margin is needed from the line of the seal material 220 to a cutting line for the incision process such that reducing a width of an outer bezel of the liquid crystal panels may be difficult.

However, in one or more exemplary embodiment of the invention, the seal material 220 is filled between the liquid crystal panels arranged in the first direction D1 and an upper portion of the seal material 220 is separated from a remainder thereof such as by cutting. Where a portion of the seal material 220 is removed, the margin from the line of the seal material 220 to a cutting line for the incision process is reduced and the width of the outer bezel of the liquid crystal panels is reduced by the incision process.

A spacer 300 is formed between the upper mother substrate 200 and the lower mother substrate 100 in the outer area (OA). The spacer may be formed on cutting lines (CL1 to CL4) used for cutting the mother substrates 100 and 200.

In this instance, the cutting lines (CL1 to CL4) include a first cutting line CL1 elongated in the first direction D1 in the outer area (OA) that is adjacent to the seal material 220, a second cutting line CL2 elongated parallel with the first cutting line CL1 in the outer area (OA) and forming a pad area (PA) together with the first cutting line CL1, a third cutting line CL3 traversing the display areas (DA) and the outer area (OA) and elongated in a second direction D2 that is perpendicular to the first direction D1, and a fourth cutting line CL4 elongated in the first direction D1 in the sealing area (SA).

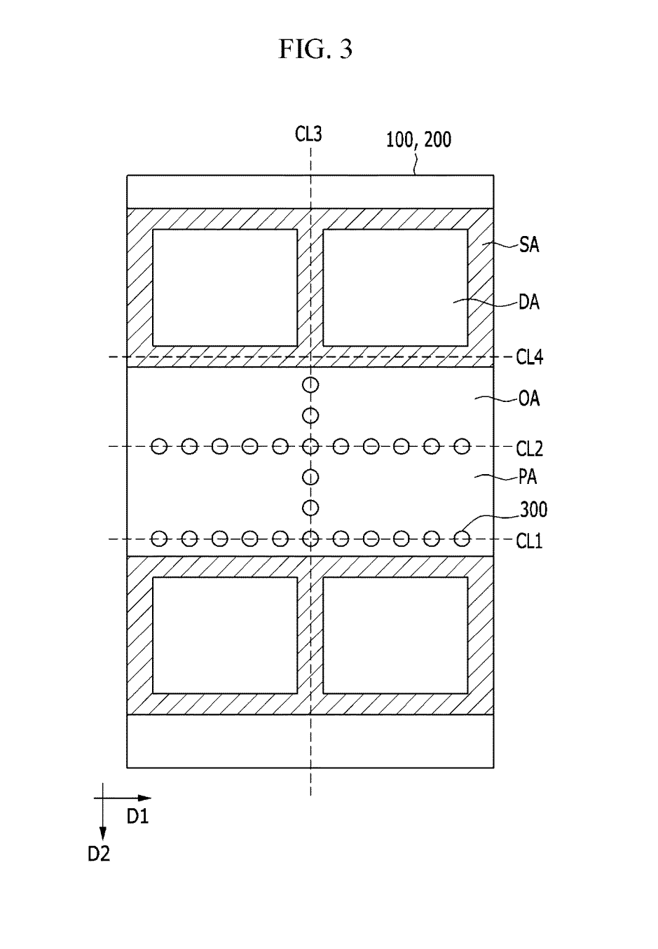

That is, the spacers 300 can be arranged in series along and near (e.g., not overlapping) the first cutting line CL1 to the fourth cutting line CL4 in the outer area (OA) as shown in FIG. 2. In an exemplary embodiment, the spacers 300 can be arranged in series along and below (e.g., overlapping) the first cutting line CL1 to the third cutting line CL3 in the outer area (OA) as shown in FIG. 3.

Further, in the plan view, the spacers 300 can be formed with a circular-type pattern as illustrated in FIG. 1 and FIG. 3, but are not limited thereto.

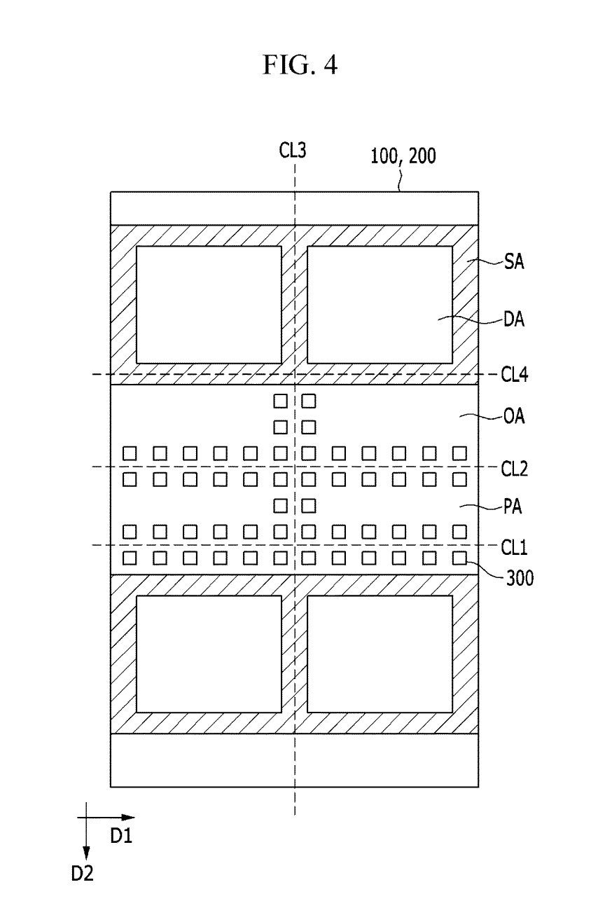

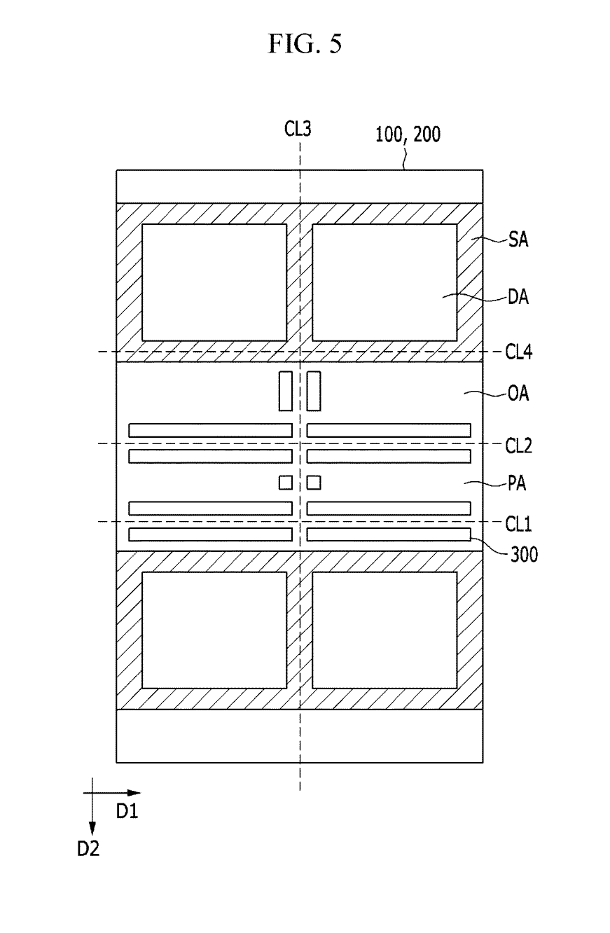

FIG. 3 to FIG. 5 show top plan views of other exemplary embodiments of a mother substrate for a display device according to the invention. The spacers 300 can be formed with a square-type pattern as shown in FIG. 4 or a bar-type pattern as shown in FIG. 5.

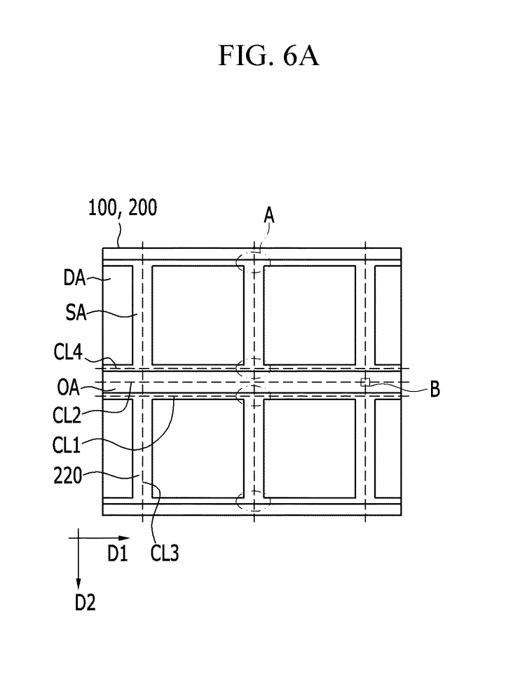

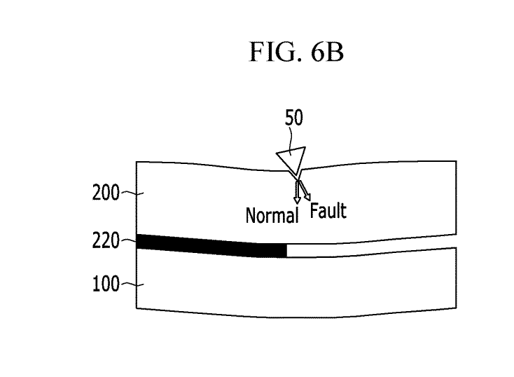

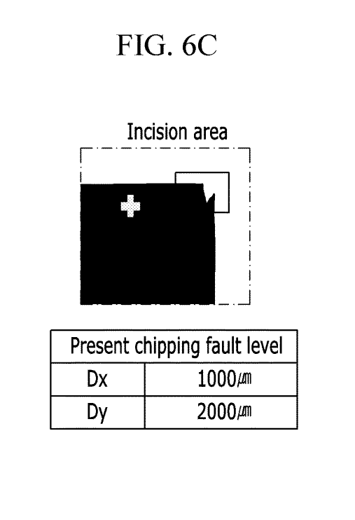

FIG. 6A to FIG. 6C show views of a comparative example of a mother substrate for a display device, not including a spacer of an exemplary embodiment of the invention.

Referring to the top plan view of FIG. 6A, the upper mother substrate 200 and the lower mother substrate 100 are divided into a display area (DA) for displaying an image, a sealing area (SA) which surrounds the display area (DA) and in which a sealing material 220 for sealing the display area (DA) is disposed, and an outer area (OA) to be incised and to separate respective liquid crystal panels at an outer side of the sealing area (SA).

Referring to FIG. 6B as an enlarged cross-sectional view of portion A of FIG. 6A, the upper mother substrate 200 and the lower mother substrate 100 are incised along the cutting lines (CL1 to CL4) by using a scribing blade 50, thereby forming respective liquid crystal panels.

In this instance, the comparative example of mother substrate for a display device is not completely vertically cracked in a thickness direction of the substrate in the outer area (OA) that is near the sealing area (SA) in the incision process. The collective mother substrate is not completely vertically incised because of a stress difference between the sealing area (SA) in which the seal material 220 is provided and the outer area (OA) in which the seal material 220 is not provided, so a glass break occurs.

Further, the substrate incision area where the second cutting line CL2 elongated in the first direction D1 crosses the third cutting line CL3 elongated in the second direction D2 is relatively thinner than that in the sealing area (SA), so intensity of a load of the scribing blade 50 is less to thus generate a chipping fault. Referring to FIG. 6C as an enlarged plan view of portion B of FIG. 6A, a chipping fault is illustrated and has dimensions Dx and Dy in directions D1 and D2, of 1000 micrometers (μm) and 2000 μm respectively.

However, one or more exemplary embodiment of the mother substrate for a display device according to the invention includes a spacer 300 for reducing the stress difference between the sealing area (SA) with the seal material 220 and the outer area (OA) without the seal material 220, thereby improving separation of respective liquid crystal panels by a vertical glass break, reducing the chipping fault and accordingly improving a yield in a method of manufacturing a liquid crystal display panel.

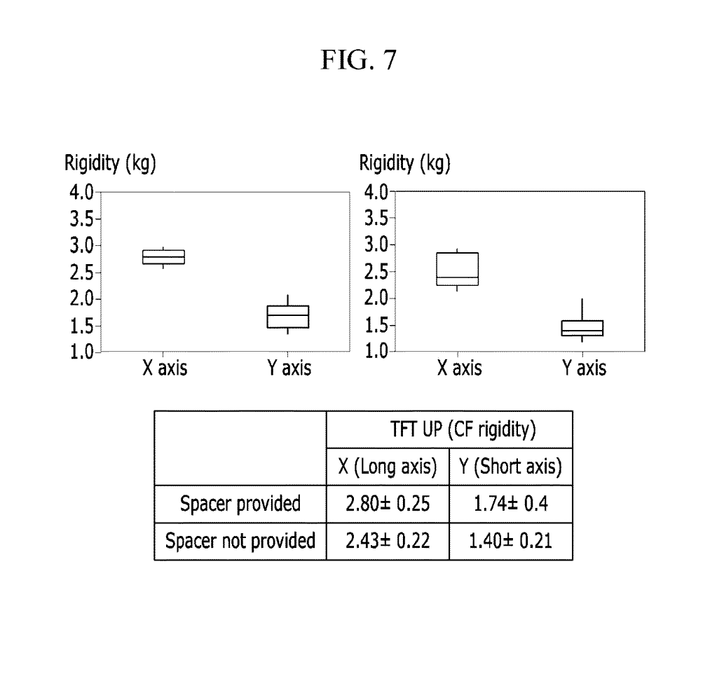

FIG. 7 shows images for describing a glass break of a mother substrate depending on whether a spacer is provided on the mother substrate. In detail, the comparative example of the mother substrate for a display device has no spacer, but an exemplary embodiment of the mother substrate for a display device according to the invention has a spacer.

Referring to FIG. 7, glass break states at the crossing point of the first cutting line CL1 and the third cutting line CL3 on both the comparative example of the mother substrate for a display device and the exemplary embodiment of the mother substrate for a display device according to the invention are known.

Compared to the comparative example of the mother substrate for a display device, a rigidity (kilograms:kg) of the exemplary embodiment of the mother substrate for a display device according to the invention including the spacer 300 is increased by 15%. That is, with an increased rigidity, the glass break is reduced in the incision process.

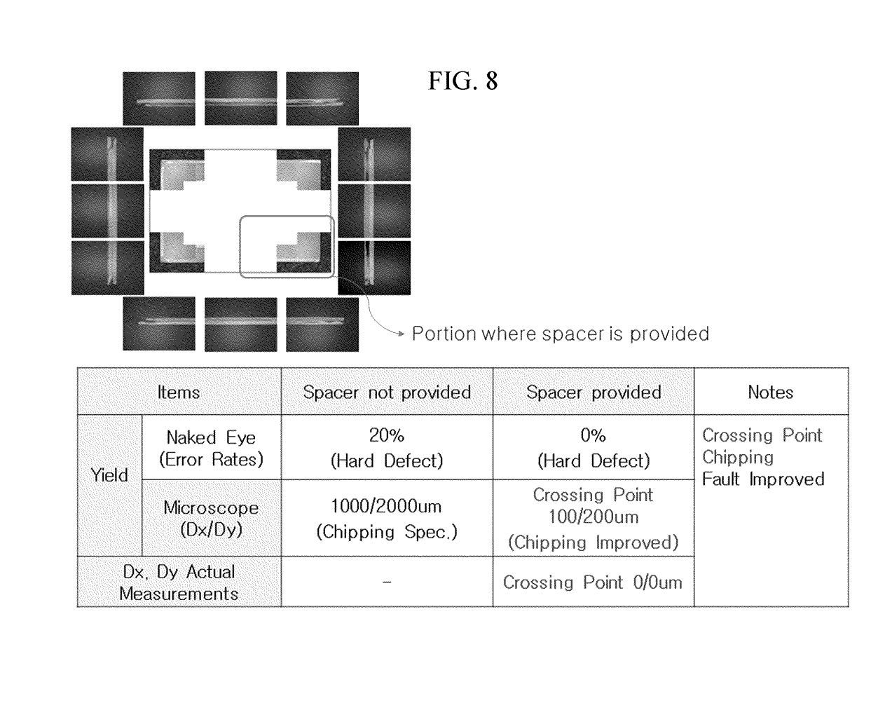

FIG. 8 shows images for describing a chipping fault depending on whether a spacer is provided. In detail, the comparative example of the mother substrate for a display device has no spacer and the exemplary embodiment of the mother substrate for a display device according to the invention has a spacer 300.

Referring to FIG. 8, glass break states at the crossing point of the second cutting line CL2 and the third cutting line CL3 on both the comparative example of the mother substrate for a display device and the exemplary embodiment of the mother substrate for a display device according to the invention are known.

The exemplary embodiment of the mother substrate for a display device according to the invention includes a spacer 300 near the area where the second cutting line CL2 crosses the third cutting line CL3 and where the substrate is relatively thinner than the sealing area (SA), thereby reducing the chipping fault that occurs because of low rigidity for the load of the scribing blade 50.

The comparative example of the mother substrate for a display device generates a 20 percent (%) error rate found with the naked eye, and the exemplary embodiment of the mother substrate for a display device according to the invention generates no errors found with the naked eye.

Further, in the case of observation with a microscope, a chipping specification with respect to planar width (Dx)/height (Dy) is 1000 μm/2000 μm in the comparative example, and it is 100 μm/200 μm according to the exemplary embodiment of the invention, so the chipping fault is improved.

That is, the exemplary embodiment of the mother substrate for a display device according to the invention includes a spacer 300 near or below the cutting line of the outer area, thereby reducing the glass break and chipping fault rates that may occur during the process for incising the liquid crystal panels, and improving the yield in a method of manufacturing a liquid crystal display panel.

Referring again to FIG. 1 and FIG. 2, the spacer 300 can be formed in a same layer as and/or including a same material as at least one of the light blocking member 211, the color filter 213 and the column spacer 219 included in the display area (DA) of the upper substrate 200, but the invention is not limited thereto. In an exemplary embodiment of a method of manufacturing a liquid crystal display panel, the spacer 300 can be formed with (e.g., in a same process and/or at a same time as) at least one of the light blocking member 211, the color filter 213 and the column spacer 219 included in the display area (DA) of the upper substrate 200.

In further detail, the spacer 300 includes a light blocking member pattern 311 including the same material as the light blocking member 211, a color filter pattern 313 including the same material as the color filter 213, and a column spacer pattern 319 including the same material as the column spacer 219.

That is, when the light blocking member 211, the color filter 213, and the column spacer 219 included in the display area (DA) of the upper substrate 200 are formed in an exemplary embodiment of a method of manufacturing a liquid crystal display panel, the spacer 300 is also formed with these elements so the spacer 300 is formed without an additional process.

In an exemplary embodiment, the spacer 300 can include the same material as, be in the same layer as and/or formed at the same time or process as the overcoat 215 or the common electrode 217.

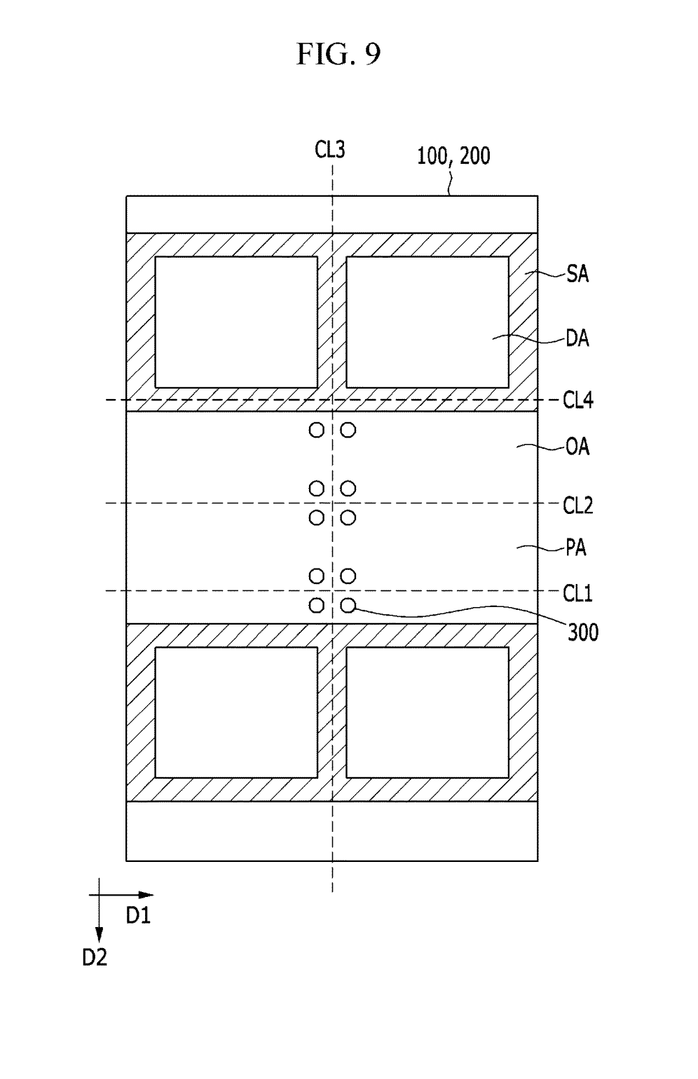

FIG. 9 to FIG. 12 show top plan views of still other exemplary embodiments of a mother substrate for a display device according to the invention. The mother substrate in FIG. 9 to FIG. 12 corresponds to the mother substrate for a display device described with reference to FIG. 1 and FIG. 2 except for modification of a position and a structure of the spacer 300. Therefore, like configurations will have like reference numerals, and no repeated description of the same configurations will be provided.

Referring to FIG. 9, the spacer 300 of the mother substrate for a display device according to the invention can be formed to be circular near the crossing area of the first cutting line CL1 to the fourth cutting line CL4 in the outer area (OA), and near (e.g., not overlapping) the third cutting line CL3 in the outer area (OA) that is adjacent to the sealing area (SA). In the exemplary embodiment, the spacer 300 may be formed only near these locations as illustrated in the figure.

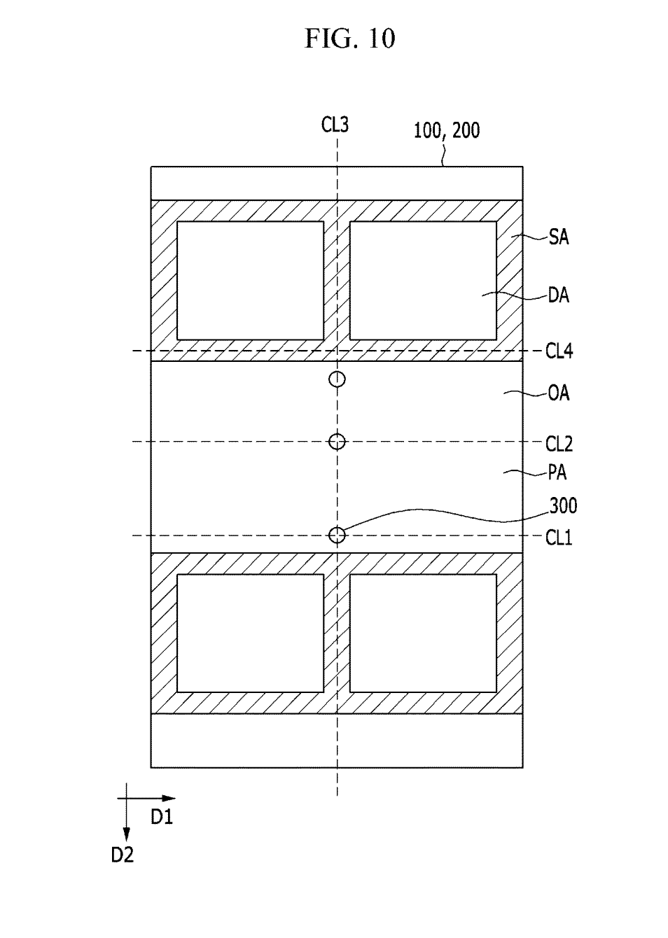

As another exemplary embodiment, as shown in FIG. 10, the spacer 300 can be formed to be circular below (e.g., overlapping) the crossing area of the first cutting line CL1 to the fourth cutting line CL4 in the outer area (OA), and below the third cutting line CL3 in the outer area (OA) that is adjacent to the sealing area (SA). In the exemplary embodiment, the spacer 300 may be formed only below these locations as illustrated in the figure.

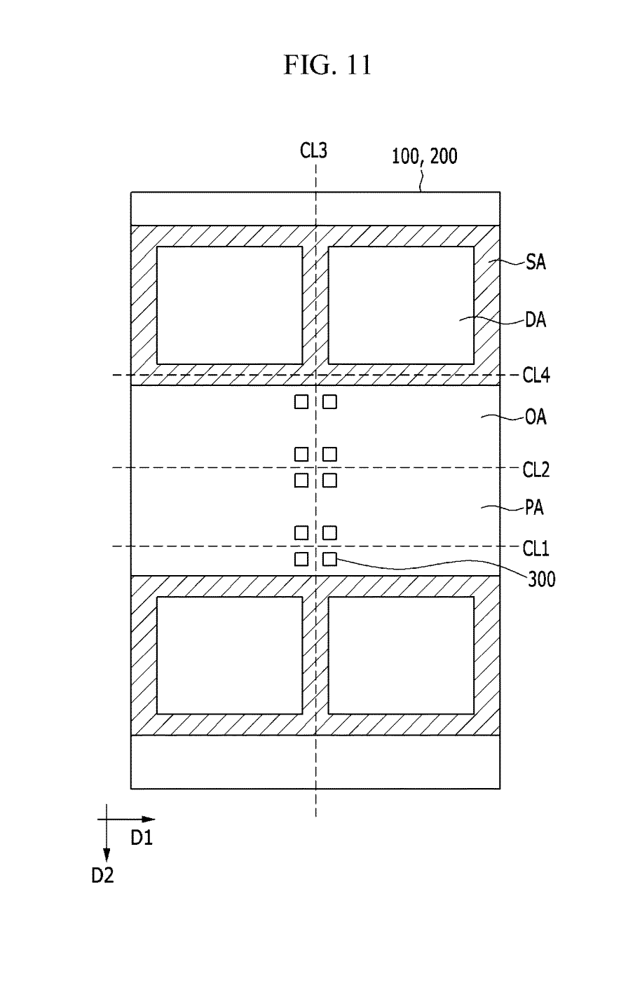

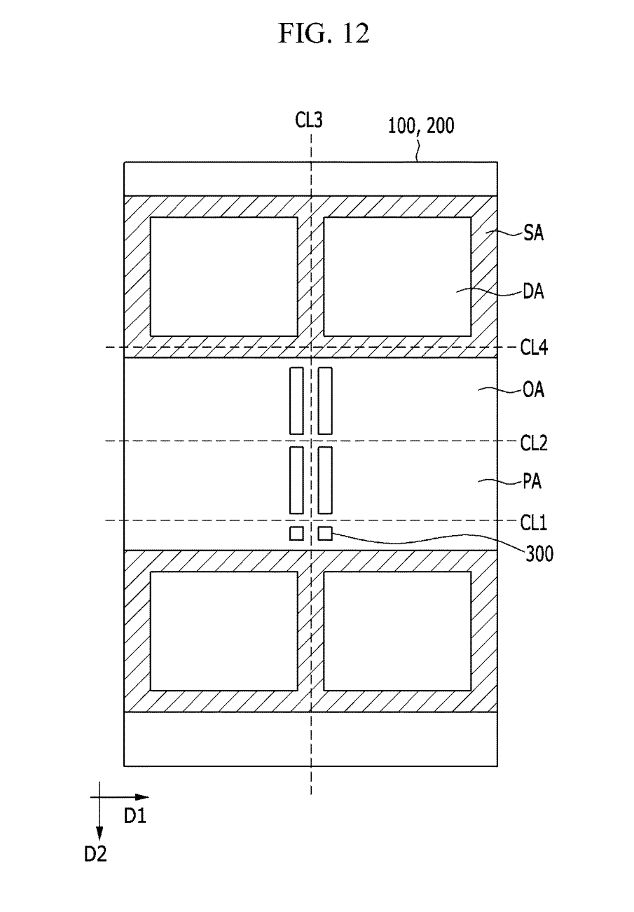

As another exemplary embodiment, as shown in FIG. 11, the spacer 300 can be formed as a square pattern near the crossing area of the first cutting line CL1 to the fourth cutting line CL4 in the outer area (OA), and near the third cutting line CL3 in the outer area (OA) that is adjacent to the sealing area (SA). Or as shown in FIG. 12, the spacer 300 can be formed as a bar pattern near the crossing area of the first cutting line CL1 to the fourth cutting line CL4 in the outer area (OA), and near the third cutting line CL3 in the outer area (OA) that is adjacent to the sealing area (SA). In the exemplary embodiment, the spacer 300 may be formed only near these locations as illustrated in the figures, or only overlapping these locations similar to that shown in FIG. 10.

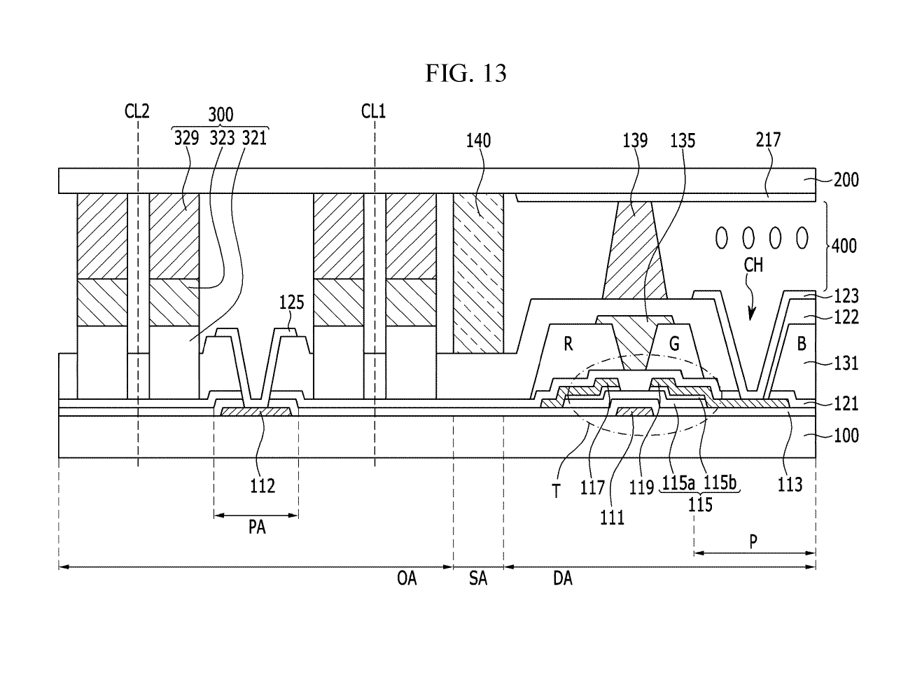

FIG. 13 shows a cross-sectional view of another exemplary embodiment of a mother substrate for a display device according to the invention. The mother substrate of FIG. 13 corresponds to the mother substrate for a display device described with reference to FIG. 1 and FIG. 2 except that a color filter 131, a light blocking member 135, and a column spacer 139 are formed on the lower substrate 100, and the spacer 300 formed with at least one of the color filter 131, the light blocking member 135, and the column spacer 139 is disposed on the lower substrate 100. The repeated descriptions on the same configurations will be omitted.

Referring to FIG. 1 and FIG. 13, the lower substrate 100 and the upper substrate 200 that are divided into a display area (DA) for displaying an image, a sealing area (SA) which surrounds the display area (DA) and in which a seal material 140 is formed, and an outer area (OA) having a pad area (PA) and formed outside the sealing area (SA) and applying a signal to the display area (DA) face each other with the liquid crystal layer 400 therebetween.

In one exemplary embodiment, a gate line (not shown) crosses a data line (not shown) to define a pixel (P) on the lower substrate 100 of the display area (DA), and a thin film transistor (T) that is a switching element configured with a gate electrode 111, a gate insulating layer 113, a semiconductor layer 115, source and drain electrodes 117 and 119, and a first passivation layer 121 is provided at the crossing point of the gate line (not shown) and the data line (not shown).

Red (R), green (G), and blue (B) color filters 131 are disposed on the first passivation layer 121, and the light blocking member 135 is disposed corresponding to the thin film transistor (T).

A second passivation layer 122 is disposed on the color filters 131, and a pixel electrode 123 and the column spacer 139 are disposed on the second passivation layer 122.

The pixel electrode 123 is connected to the drain electrode 119 through a contact hole (CH), and the column spacer 139 maintains the gap between the lower substrate 100 and the upper substrate 200 so that a liquid crystal material of the liquid crystal layer 400 may be fluidly injected.

A seal material 140 is coated on the lower substrate 100 of the sealing area (SA) to block leakage of the liquid crystal layer 400.

A spacer 300 is formed (e.g., provided) on the lower substrate 100 of the outer area (OA).

In an exemplary embodiment of a method of manufacturing a liquid crystal display panel, the spacer 300 can be formed with (e.g., in a same process and/or at a same time as) at least one of the color filter 131, the light blocking member 135 and the column spacer 139 included in the display area (DA) of the lower substrate 100, but the invention is not limited thereto.

In further detail, the spacer 300 can be collectively formed inclusive of a color filter pattern 321 including the same material and/or in a same layer as the color filter 131, a light blocking member pattern 323 including the same material and/or in a same layer as the light blocking member 135, and a column spacer pattern 329 including the same material and/or in a same layer as the column spacer 139.

That is, when the color filter 131, the light blocking member 135, and the column spacer 139 included in the display area (DA) of the lower substrate 100 are formed in an exemplary embodiment of a method of manufacturing a liquid crystal display panel, the spacer 300 is formed together with these elements so the spacer 300 can be formed without an additional process.

In an exemplary embodiment, the spacer 300 can include the same material as, be in the same layer as and/or formed at the same time or process as the second passivation layer 122 or the pixel electrode 123. Or the spacer can be collectively formed further inclusive of the same material as the second passivation layer 122 or the pixel electrode 123.

A common electrode 217 is disposed in the display area (DA) of the upper substrate 200.

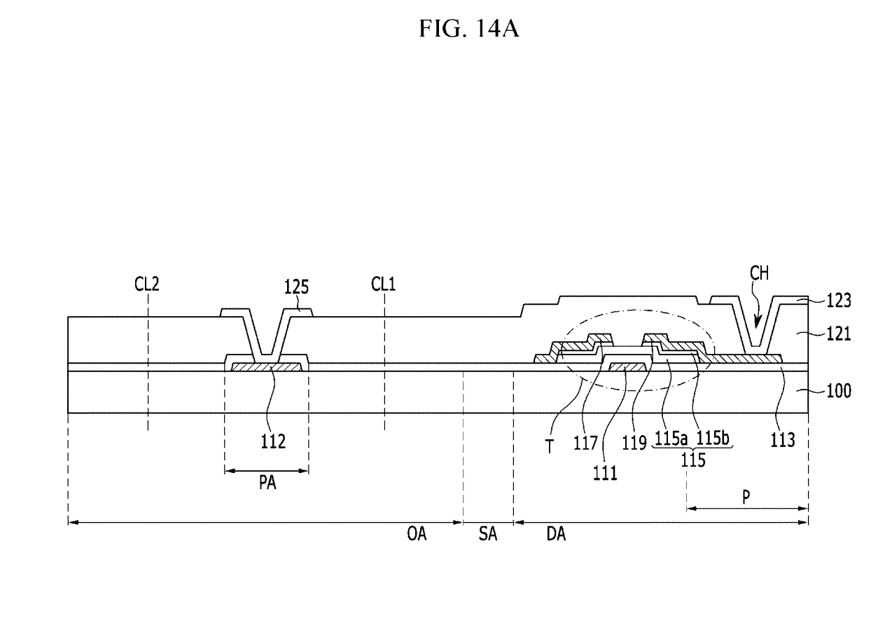

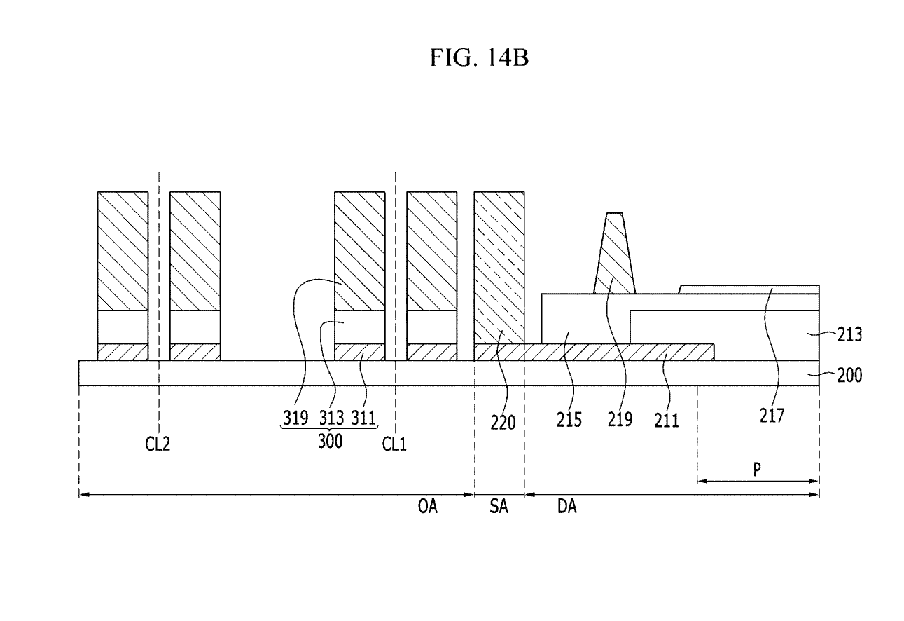

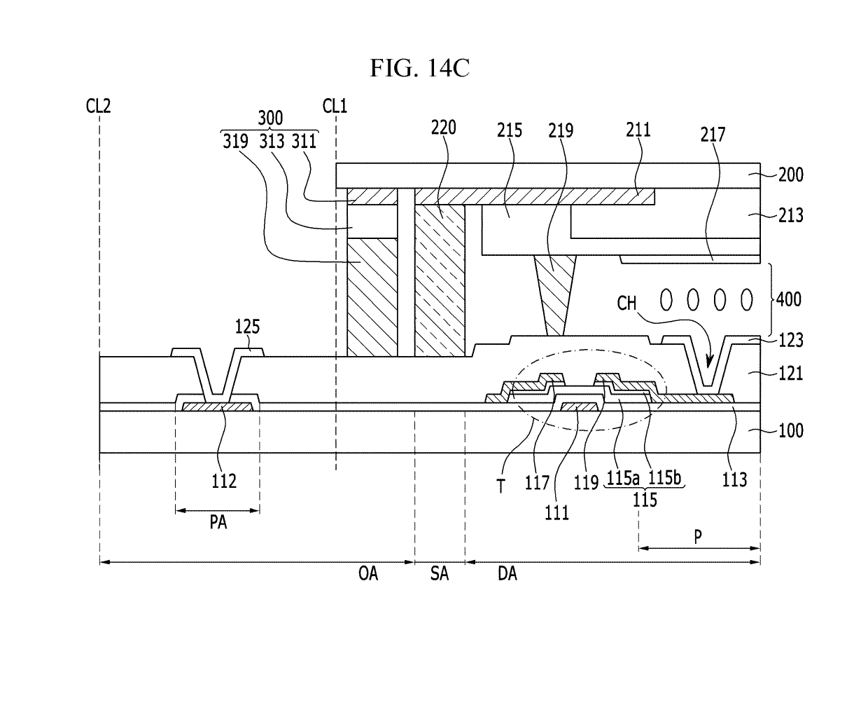

An exemplary embodiment of a method for manufacturing a display device according to the invention will now be described with reference to FIG. 14A to FIG. 14C. A method for respectively manufacturing an upper substrate and a lower substrate will be described, and a process for combining them and incising them will then be described.

FIG. 14A to FIG. 14C are diagrams for showing an exemplary embodiment of manufacturing a display device according to the invention, including using a mother substrate for a display device described with reference to FIG. 1 and FIG. 2. Therefore, like configurations will have like reference numerals, and no repeated description of the same configurations will be provided.

A method for manufacturing a lower mother display substrate will now be described with reference to FIG. 14A. The lower mother display substrate includes the lower mother substrate 100 and the elements formed thereon.

A conductive film is deposited on the lower mother substrate 100, a photoresist pattern is formed on the deposited conductive film, and a mask process for sequentially performing an exposure, development and etching process is used to pattern-form storage electrode wiring (not shown) including a gate electrode 111 and a storage electrode in the display area (DA) and a gate or data pad electrode 112 in the pad area (PA) of the outer area (OA). Pattern formation of the respective configurations to be described is performed by using the mask process including the exposure, development and etching process.

A thin film transistor (T) that is a switching element sequentially configured with a gate insulating layer 113, a semiconductor layer 115, source and drain electrodes 117 and 119, and a passivation layer 121 is formed on the lower mother substrate 100 of the display area (DA).

In this instance, the semiconductor layer 115 can be configured with an active layer 115a including intrinsic amorphous silicon and an ohmic contact layer 115b including impurity-included amorphous silicon.

A pixel electrode 123 connected to the drain electrode 119 through the contact hole (CH) is pattern-formed on the passivation layer 121 of the lower mother substrate 100, and a gate or data pad terminal electrode 125 is pattern-formed on the passivation layer 121 of the pad area (PA).

A method for manufacturing an upper mother display substrate will now be described with reference to FIG. 14B. The upper mother display substrate includes the upper mother substrate 200 and the elements formed thereon.

A light blocking member 211 in a lattice shape for surrounding the pixel (P) and to cover an area which does not contribute to driving of liquid crystal, such as an edge of the pixel electrode 123, from the light and exposing the pixel electrode 123 is pattern-formed on the upper mother substrate 200. In this instance, the light blocking member pattern 311 of the spacer 300 is pattern-formed with the same material as the display area (DA) light blocking member 211, in the outer area (OA) of the upper mother substrate 200.

Color filters 213 that are sequentially and repeatedly arranged corresponding to the respective pixels (P) are pattern-formed inside the lattice of the light blocking member 211. The color filter pattern 313 of the spacer 300 is formed with the same material as the display area (DA) color filter 213, in the outer area (OA) of the upper mother substrate 200.

An overcoat 215 for covering the light blocking member 211 and the color filter 213 is pattern-formed in the display area (DA) of the upper mother substrate 200.

The common electrode 217 is pattern-formed on the overcoat 215.

The column spacer 219 is pattern-formed in the display area (DA) of the upper mother substrate 200. The column spacer pattern 319 of the spacer 300 is pattern-formed with the same material as the display area (DA) column spacer 219, in the outer area (OA).

That is, when the light blocking member 211, the color filter 213 and the column spacer 219 included in the display area (DA) of the upper mother substrate 200 are formed, the spacer 300 including the light blocking member pattern 311, the color filter pattern 313 and the column spacer pattern 319 are formed together therewith (e.g., at a same time or with a same process, respectively) so the spacer 300 can be formed without an additional process.

In this instance, the spacer 300 can be configured with at least one of the light blocking member 211, the color filter 213 and the column spacer 219, and the spacer 300 can be formed with at least one of the circle, square or bar shape patterns.

Although not shown, in an exemplary embodiment, the spacer 300 can be formed with the same material as the overcoat 215 or the common electrode 217, or can be collectively formed further inclusive of the same material as the overcoat 215 or the common electrode 217.

A seal material 220 for surrounding the display area (DA) is formed in the sealing area (SA) of the upper mother substrate 200. The seal material 220 can be formed by using a sealant.

A division method of respective display cells, that is, display panels, through an incision process will now be described with reference to FIG. 1 and FIG. 14C.

The lower mother display substrate including the lower mother substrate 100 and elements thereon, and the upper mother display substrate including the upper mother substrate 200 and elements thereon, are arranged to face each other.

The mother display substrates of which positions are arranged are pressurized at a high temperature to melt the seal material 220, cure the same, and thereby bond the lower mother substrate 100 and the upper mother substrate 200 including elements thereon, to each other.

A liquid crystal material is injected into a predetermined space formed by the seal material 220 such as by using a vacuum injection method to form a liquid crystal layer 400.

The upper mother substrate 200 is incised.

In this instance, the upper mother substrate 200 is incised along the first cutting line CL1 elongated in the first direction D1 in the outer area (OA) that is adjacent to the seal material 220, and it is incised along the second cutting line CL2 that is elongated parallel to the first cutting line CL1 and that forms the pad area (PA) in the outer area (OA).

The lower mother substrate 100 is incised.

In this instance, the lower mother substrate 100 is incised along the third cutting line CL3 that traverses between the display area (DA) and the outer area (OA) and that is elongated in the second direction D2 that is perpendicular to the first direction D1. The lower mother substrate 100 is incised along the fourth cutting line CL4 in the first direction D1 in the sealing area (SA).

As described, one or more exemplary embodiment of the collective mother substrate for a display device according to the invention is incised along the first to fourth cutting lines (CL1 to CL4) to complete the display devices that include respective liquid crystal panels.

That is, one or more exemplary embodiment of a display device according to the invention can be formed inclusive of the spacer 300 that is formed in the outer area (OA) of the upper substrate 200 and is formed near the seal material 220 along the first cutting line CL1.

In this instance, the spacer 300 can be formed with at least one of the light blocking member 211, the color filter 213 and the column spacer 219 included on the upper substrate 200.

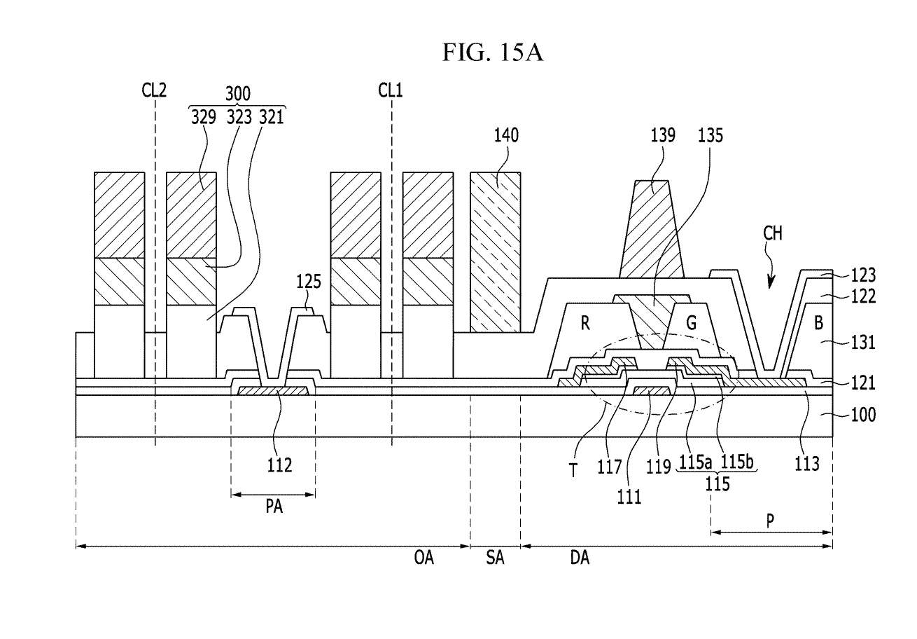

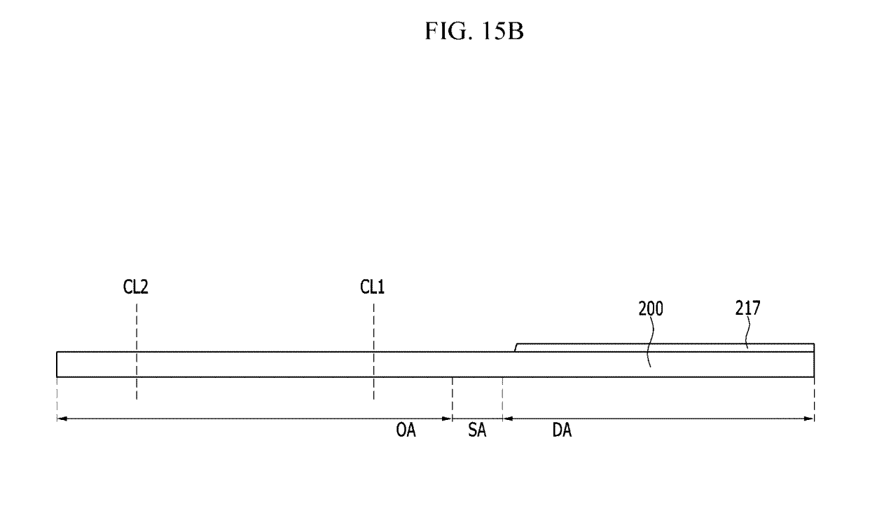

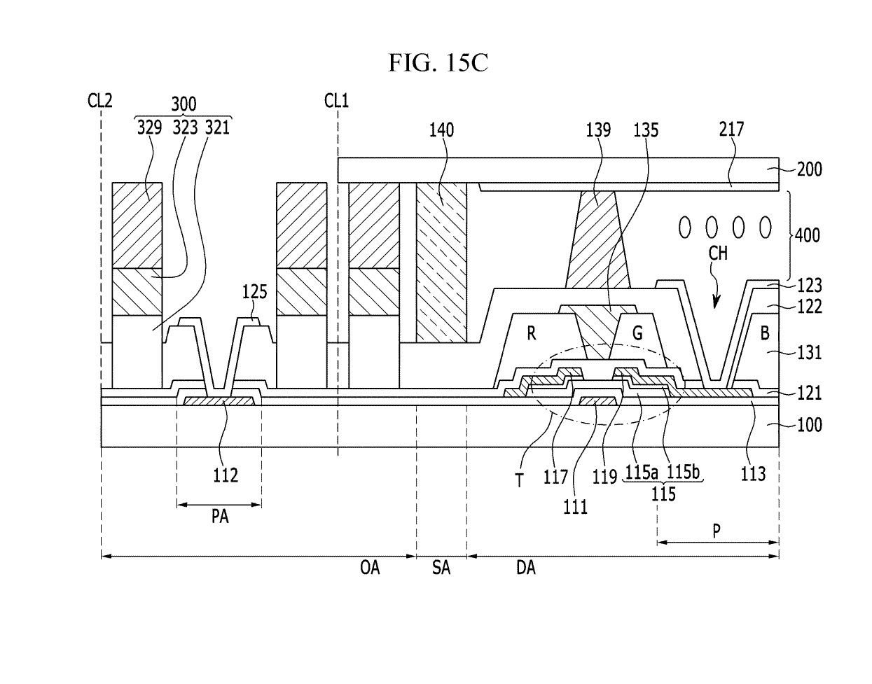

Another exemplary embodiment of a method for manufacturing a display device according to the invention will now be described with reference to FIG. 15A to FIG. 15C. A method for respectively manufacturing an upper mother substrate and a lower mother substrate will be described, and a process for combining them and incising them will then be described.

FIG. 15A to FIG. 15C are diagrams for showing another exemplary embodiment of manufacturing a display device according to the invention, including using a mother substrate for a display device described with reference to FIG. 1 and FIG. 13. The exemplary embodiment in FIG. 15A to FIG. 15C corresponds to the processing diagrams for manufacturing a display device described with reference to FIG. 14A to FIG. 14C, except that the color filter 131, the light blocking member 135, the column spacer 139 and the spacer 300 are formed on the lower mother substrate 100. Therefore, no repeated descriptions of the same configuration and manufacturing method will be provided.

A method for manufacturing a lower mother display substrate will now be described with reference to FIG. 15A. The lower mother display substrate includes the lower mother substrate 100 and the elements formed thereon.

A thin film transistor (T) that is a switching element sequentially configured with a gate electrode 111, a gate or data pad electrode 112, a gate insulating layer 113, a semiconductor layer 115, source and drain electrodes 117 and 119, and a first passivation layer 121 is pattern-formed on the lower mother substrate 100 of the display area (DA).

Red (R), green (G), and blue (B) color filters 131 are pattern-formed on the first passivation layer 121, and the light blocking member 135 is pattern-formed corresponding to the thin film transistor (T).

A color filter pattern 321 of the spacer 300 is formed with the same material as the display area (DA) color filter 131, in the outer area (OA) of the lower mother substrate 100. A light blocking member pattern 323 of the spacer 300 is formed with the same material as the display area (DA) light blocking member 135, in the outer area (OA) of the lower mother substrate 100.

A second passivation layer 122 is pattern-formed on the color filter 131, and a pixel electrode 123 and a column spacer 139 are pattern-formed on the second passivation layer 122.

The column spacer pattern 329 of the spacer is formed with the same material as the display area (DA) column spacer 139, in the outer area (OA) of the lower mother substrate 100, and the gate or data terminal electrode 125 is pattern-formed in the pad area (PA).

That is, the spacer 300 can be formed in the outer area (OA) of the lower mother substrate 100, with at least one of the color filter 131, the light blocking member 135, and the column spacer 139 included in the display area (DA).

When the color filter 131, the light blocking member 135 and the column spacer 139 included in the display area (DA) of the lower mother substrate 100 are formed, the spacer 300 is formed together therewith (e.g., at a same time or with a same process, respectively) so the spacer 300 can be formed without an additional process.

Although not shown, in an exemplary embodiment, the spacer 300 can be collectively formed further inclusive of the same material as the second passivation layer 122 or the pixel electrode 123.

In this instance, the spacer 300 can be configured with at least one of the color filter 131, the light blocking member 135 and the column spacer 139, and the spacer 300 can be formed with at least one of the circle, square or bar shape patterns.

A seal material 140 for surrounding the display area (DA) is formed in the sealing area (SA) of the lower mother substrate 100. The seal material 140 can be formed by use of a sealant.

A method for manufacturing an upper mother display substrate will now be described with reference to FIG. 15B.

A common electrode 217 is formed in the display area (DA) of the upper mother substrate 200.

A division method of respective display cells that are display panels will now be described with reference to FIG. 1 and FIG. 15C.

The lower mother display substrate including the lower mother substrate 100 and elements thereon and the upper mother display substrate including the upper mother substrate 200 and elements thereon are arranged to face each other.

The mother display substrates of which positions are arranged are pressurized at a high temperature to melt the seal material 140, cure the same, and then bond the lower mother substrate 100 and the upper mother substrate 200 including elements thereon, to each other.

A liquid crystal material is injected into a predetermined space formed by the seal material 140 such as by using a vacuum injection method to form a liquid crystal layer 400.

The upper mother substrate 200 is incised along the first cutting line CL1 and the second cutting line CL2.

The lower mother substrate 100 is incised along the third cutting line CL3 and the fourth cutting line CL4.

As described above, one or more exemplary embodiment of the collective mother substrate for a display device according to the invention is incised along the first to fourth cutting lines (CL1 to CL4) to complete display devices that include respective liquid crystal panels.

That is, one or more exemplary embodiment of a display device according to the invention can be formed inclusive of the spacer 300 that is formed in the outer area (OA) of the lower substrate 100 and that is formed near the first to fourth cutting lines (CL1 to CL4).

In this instance, the spacer 300 can be formed with at least one of the color filter 131, the light blocking member 135 and the column spacer 139 included on the lower substrate 100.

The gate insulating layer 113, the first passivation layer 121 and the second passivation layer 122 may include a silicon oxide (SiOx) layer or a silicon nitride (SiNx) layer, and may include a single layer of the oxide layer or the nitride layer or multiple layers thereof with at least two layers.

The pixel electrode 123 and the common electrode 217 may include a transparent conductive material such as indium tin oxide (“ITO”), indium zinc oxide (“IZO”) or zinc oxide (ZnO).

The column spacers 139 and 219 may include an organic film such as an acryl or benzocyclobutene (“BCB”).

While this invention has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A mother substrate for a display device, comprising:
an upper mother substrate and a lower mother substrate each divided into, from among areas of the display device, a display area which displays an image, a sealing area which surrounds the display area and in which a seal material is disposed, and an outer area disposed outside the sealing area, in which a pad area is disposed and from which a signal is applied to the display area; and
a spacer between the upper mother substrate and the lower mother substrate, and in the outer area,
wherein the spacer is disposed at a cutting line at which the upper mother substrate and the lower mother substrate are separated from the mother substrate to form the display device.

2. The mother substrate of claim 1, further comprising a plurality of cutting lines comprising:
a first cutting line elongated in a first direction and in the outer area adjacent to the seal material;
a second cutting line elongated parallel with the first cutting line, in the outer area, and defining the pad area;
a third cutting line elongated in a second direction perpendicular to the first direction, and extending through the outer area and between display device display areas adjacent in the first direction; and
a fourth cutting line elongated in the first direction and in the sealing area.

3. The mother substrate of claim 2, further comprising a plurality of spacers,
wherein
the spacers are arranged in series adjacent to the first to fourth cutting lines and along the first to fourth cutting lines in the outer area.

4. The mother substrate of claim 2, further comprising a plurality of spacers,
wherein
the spacers are arranged in series overlapping the first to fourth cutting lines and along the first to fourth cutting lines in the outer area.

5. The mother substrate of claim 4, wherein
the spacers have a circle, square or bar shape.

6. The mother substrate of claim 2, further comprising a plurality of spacers,
wherein
the spacers are only disposed adjacent a crossing area of the first cutting line to fourth cutting line in the outer area and adjacent the third cutting line adjacent the sealing area in the outer area.

7. The mother substrate of claim 2, further comprising a plurality of spacers,
wherein
the spacers are only disposed overlapping a crossing area of the first cutting line to fourth cutting line in the outer area and overlapping the third cutting line and the fourth cutting line in the outer area adjacent to the sealing area.

8. The mother substrate of claim 7, wherein
the spacers have a circle, square or bar shape.

9. The mother substrate of claim 1, wherein
the spacer comprises the same material as at least one of a display area light blocking member, a display area color filter and a display area column spacer on the upper mother substrate.

10. The mother substrate of claim 1, wherein
the spacer comprises the same material as at least one of a display area color filter, a display area light blocking member and a display area column spacer on the lower mother substrate.

11. A display device comprising:
an upper substrate and a lower substrate each comprising a display area which displays an image, a sealing area which surrounds the display area and in which a seal material is disposed, and an outer area disposed outside the sealing area, in which a pad area is disposed and from which a signal is applied to the display area; and
a spacer between the upper substrate and the lower substrate, and in the outer area,
wherein the spacer is disposed at a cutting line of a mother substrate at which the upper substrate and the lower substrate are separated from the mother substrate to form the display device.

12. The display device of claim 11, wherein
the mother substrate comprises a plurality of cutting lines comprising:
a first cutting line elongated in a first direction and in the outer area adjacent to the seal material;
a second cutting line elongated in parallel with the first cutting line, in the outer area, and defining the pad area;
a third cutting line elongated in a second direction perpendicular to the first direction, and extending through the outer area and between mother substrate display device display areas adjacent in the first direction; and
a fourth cutting line elongated in the first direction and in the sealing area.

13. The display device of claim 12, wherein
the spacer is disposed in the outer area of the upper substrate, and is disposed adjacent the seal material along the first cutting line.

14. The display device of claim 13, wherein
the spacer comprises the same material as at least one of a display area light blocking member, a display area color filter and a display area column spacer on the upper substrate.

15. The display device of claim 12, wherein
the spacer is disposed in the outer area of the lower substrate, and is disposed adjacent the first to fourth cutting lines.

16. The display device of claim 15, wherein
the spacer comprises the same material as at least one of a display area color filter, a display area light blocking member and a display area column spacer disposed on the lower substrate.

17. A method for manufacturing a display device, comprising:
providing an upper mother substrate and a lower mother substrate each divided into, from among areas of the display device, a display area which displays an image, a sealing area which surrounds the display area and seals the display area, and an outer area disposed outside the sealing area, in which a pad area is disposed and from which a signal is applied to the display area;
forming a seal material in the sealing area of the upper mother substrate or the lower mother substrate, and forming a spacer in an outer area of the upper mother substrate or the lower mother substrate, respectively;
arranging the lower mother substrate and the upper mother substrate to face each other;
melting the seal material and curing the seal material, to bond the lower mother substrate and the upper mother substrate to each other;
incising the upper mother substrate; and
incising the lower mother substrate,
wherein
the incising the upper mother substrate comprises incising the same along
a first cutting line elongated in a first direction and in the outer area adjacent to the seal material, and
a second cutting line elongated in parallel to the first cutting line, in the outer area and defining the pad area, and
the incising of the lower mother substrate comprises incising the same along
a third cutting line elongated in a second direction perpendicular to the first direction, and extending through the outer area and between display device display areas adjacent in the first direction, and
a fourth cutting line elongated in the first direction and in the sealing area.

18. The method of claim 17, wherein
the spacer comprises a same material as at least one of a display area light blocking member, a display area color filter and a display area column spacer on the upper mother substrate.

19. The method of claim 17, wherein
the spacer comprises a same material as at least one of a display area color filter, a display area light blocking member and a display area column spacer on the lower mother substrate.
